(19) United States
(12) Patent Application Publication
(10) Pub. No.: US 2025/0360807 A1
(43) Pub. Date: Nov. 27, 2025

(54) BATTERY HOUSING

(71) Applicant: Benteler Automobiltechnik GmbH, Paderborn (DE)

(72) Inventors: Guido BLOEMEKE, Paderborn (DE); Christian HANDING, Langenberg (DE); Kai MICHEL, Salzkotten (DE); Stefan SCHMITZ, Bielefeld (DE)

(21) Appl. No.: 19/216,160

(22) Filed: May 22, 2025

(30) Foreign Application Priority Data
May 23, 2024 (EP) 24177601.2

(51) Int. Cl. B60L 50/64; H01M 50/209; H01M 50/242; H01M 50/249

(52) U.S. Cl. CPC B60L 50/64; H01M 50/209; H01M 50/242; H01M 50/249; H01M 2220/20

(57) ABSTRACT

The present disclosure relates to a battery housing for receiving multiple battery cells or battery modules. The battery housing may include a one-piece and formed receiving tray for receiving the battery cells or battery modules. The receiving tray may have a base plate and an outer wall arranged circumferentially around the base plate. A flange circumferring the outer wall may be arranged on the outer wall of the receiving tray. The batter housing may include multiple crash frame profiles arranged on at least two side wall sections of the outer wall, which may be adapted to absorb forces acting on the receiving tray. The battery housing may include multiple cross members, which may each be connected to two crash frame profiles of the crash frame profiles. The cross members may have a greater tensile strength or stiffness in cross member end sections compared to a cross member center section.

### CROSS REFERENCE

The present application claims the benefit of European Patent Application No. 24177601.2 by Bloemeke et al., entitled “BATTERIEEINHAUSUNG”, filed May 23, 2024, which is assigned to the assignee hereof and is incorporated herein by reference in its entirety.

### TECHNICAL FIELD

The present disclosure relates to a battery housing for receiving a plurality of battery cells or battery modules, in particular in an electrically driven vehicle.

### BACKGROUND

Battery housings are used in a wide range of technical applications to house batteries, in particular battery cells and/or battery modules, and to protect them from external environmental influences, for example to provide electrical energy in electrically powered vehicles.

Due to the risk of vehicle fires from damaged battery cells, the respective battery cells and/or battery modules must be housed in sturdy receiving trays that provide adequate protection for the battery cells and/or battery modules even in a vehicle collision. Such sturdy receiving trays often have deformation elements that effectively absorb the forces generated in a vehicle collision through deformation, thereby protecting the battery cells arranged in the receiving trays from damage.

However, conventionally used deformation elements often have the disadvantage that, at correspondingly high collision speeds and/or in a side impact, the battery cells received in the receiving trays are not sufficiently protected, so that there is a need to improve the structural stability of receiving trays for receiving battery cells and/or battery modules.

In the document U.S. Pat. No. 11,813,935 B2 a tray formed from metal for holding batteries is disclosed.

### SUMMARY

It is the object of the present disclosure to provide a battery housing, which is easy to manufacture and which has a high structural stability for protecting the received battery cells and/or battery modules.

This object is achieved by the features of the independent claim. Advantageous examples are the subject of the dependent claims, the description, and the accompanying figures.

The present disclosure is based on the finding that by connecting a plurality of cross members to crash frame profiles, which are arranged on side wall sections of the outer wall of the receiving tray, the structural stability of the battery housing can be significantly increased in a case of a collision, in particular in a side impact.

The present disclosure is based on the further finding that by increasing the tensile strength or stiffness in the cross member end sections of the respective cross member compared to the cross member center section of the respective cross member, a particularly effective absorption of forces via the cross member end sections is made possible, and the absorbed forces can be advantageously introduced from the cross member end sections into the cross member center section of the respective cross member.

According to a first aspect, the disclosure relates to a battery housing for receiving a plurality of battery cells or battery modules, in particular in an electrically driven vehicle, comprising a one-piece and formed receiving tray for receiving the plurality of battery cells or battery modules, wherein the receiving tray has a base plate and an outer wall, which is arranged circumferentially around the base plate, wherein the outer wall delimits a tray interior space of the receiving tray, wherein a flange circumferring the outer wall is arranged on the outer wall of the receiving tray, which flange extends at an angle to the outer wall of the receiving tray; a plurality of crash frame profiles, which are arranged on at least two side wall sections of the outer wall of the receiving tray, and which are adapted to absorb forces acting on the receiving tray by a deformation, wherein the crash frame profiles have a plurality of coupling sections for fastening the battery housing to body longitudinal members, in particular vehicle sills; and a plurality of cross members, which are each connected to two crash frame profiles of the plurality of crash frame profiles, wherein the cross members are formed at least in sections as profile bodies, which are connected to the respective crash frame profile, and wherein the cross members have a greater tensile strength or stiffness in the cross member end sections compared to the cross member center section.

This achieves the technical advantage that by using at least two crash frame profiles, which are arranged on at least two side wall sections of the outer wall, and by connecting cross members at the crash frame profiles an effective collision protection is made possible, in particular in a side impact.

This is achieved by ensuring that when a force acts on one of the crash frame profiles, at least a part of the acting forces is diverted via the cross member connected to the crash frame profile.

Here, the respective cross member is formed at least in sections as a profile body, which is connected to the respective crash frame profile.

In particular, the respective cross member is formed at least in sections as a profile body open on at least one side, and/or in particular the respective cross member is formed least in sections as a closed profile body.

In particular, the respective cross member is completely formed as a profile body.

In particular, the respective cross member is completely formed as a profile body open on at least one side or the respective cross member is completely formed as a closed profile body.

In particular, the respective cross member is formed in sections as a profile body open on at least one side and the respective cross member is formed in sections as a closed profile body.

In particular, each cross member end section of the two cross member end sections of the respective cross member is connected to one of the two crash frame profiles of the plurality of crash frame profiles.

In particular, the two cross member end sections of the respective cross member are each formed as a profile body which is connected to the respective crash frame profile. In particular, the two cross member end sections of the respective cross member are each formed as a profile body open on at least one side or as a closed profile body which is connected to the respective crash frame profile.

In particular, the cross members formed as profile bodies open on at least one side have an open cross member bottom side, wherein in particular the open cross member bottom side is connected to the respective crash frame profiles, in particular at the respective cross member ends of the cross members.

In particular, the respective cross member center section connects the two cross member end sections of the respective cross member.

Because the cross members have a greater tensile strength or stiffness in the cross member end sections than in the cross member center section, the forces acting on the respective crash frame profile in an impact are absorbed over a large area by the cross member end sections and introduced into the cross member center section of the cross member, so that greater forces can be absorbed in a collision.

Due to the increased tensile strength or stiffness of the cross member end sections, the cross members in the remaining sections, such as the cross member center section, can be formed with smaller dimensions, thereby reducing the weight of the cross members, which is in particular relevant for electric vehicles. In addition, the main joint between the cross member and the respective crash frame profile is enlarged, providing a larger number of connection points, which in turn increases the stability of the connection between the respective cross member and the crash frame profiles.

In particular, the cross members are arranged next to one another, in particular parallel to one another.

In particular, the plurality of crash frame profiles comprises two crash frame profiles, which are arranged at two side wall sections of the outer wall of the receiving tray, in particular at two opposite side wall sections of the outer wall of the receiving tray, wherein the plurality of cross members is connected to both crash frame profiles.

Alternatively, the plurality of crash frame profiles comprises four crash frame profiles, which are arranged at all four side wall sections of the outer wall of the receiving tray, wherein the plurality of cross members is connected to two of the four crash frame profiles, which are arranged at two opposite side wall sections of the outer wall of the receiving tray.

It is further emphasized that, according to the first aspect, the crash frame profiles have a plurality of coupling sections for fastening the battery housing to body longitudinal members, in particular vehicle sills. This means that the crash frame profiles of the battery housing and the body longitudinal members, in particular vehicle sills, of the vehicle are different components.

In an example, the stiffness of the respective cross member end section is increased by a reinforcing rib extending along the respective cross member extension axis, wherein the respective reinforcing rib spreads out in the respective cross member end section into a plurality of reinforcing rib branches.

This achieves the technical advantage that the forces acting on the respective crash frame profile in an impact are absorbed over a large area by the reinforcing rib branches and introduced into the reinforcing rib of the cross member in a combined or bundled way, so that greater forces can be absorbed in a collision.

In particular, the respective reinforcing rib is arranged in the respective cross member center section of the respective cross member and the reinforcing rib branches are arranged in the respective cross member end section of the respective cross member.

In an example, the coupling sections of the crash frame profiles each have at least one passage, through which a fastening element, in particular fastening screw, can be guided in order to fasten the battery housing to the body longitudinal members, in particular vehicle sills.

This achieves the technical advantage of enabling an effective connection of the battery housing to the body longitudinal members, in particular the vehicle sills.

In particular, the fastening element, in particular fastening screw, can be guided through a further passage of the body longitudinal members, in particular the vehicle sills, and through the passage of the coupling sections of the crash frame profiles in order to fasten the crash frame profiles to the body longitudinal members, in particular the vehicle sills. In particular, a fastening nut can be screwed onto the fastening element, in particular the fastening screw.

In an example, the plurality of cross members is arranged on a base plate bottom side of the base plate facing away from the tray interior space.

This achieves the technical advantage of effectively stabilizing the base plate bottom side of the receiving tray. In particular, the cross members are connected to the base plate bottom side of the base plate.

In an example, the respective crash frame profile with the respective side wall section of the outer wall each delimits at least one hollow chamber extending along the respective side wall section, or the respective crash frame profile is a hollow chamber profile.

This achieves the technical advantage that a corresponding hollow chamber in the crash frame profile, or the formation of the crash frame profile as a hollow chamber profile, allows the outer wall of the crash frame profile to be deformed inwards and thus absorbs acting forces.

In an example, the cross members each have the cross member center section and each have two cross member end sections formed in one piece with the cross member center section, wherein the cross member end sections are each formed as profile bodies, which are connected to the respective crash frame profile, and wherein the plurality of reinforcing rib branches of the respective reinforcing rib is formed in the respective cross member end section.

In particular, the reinforcing rib extending along the respective cross member extension axis is arranged in the cross member center section.

This achieves the technical advantage that the end-side formation of the cross members as profile bodies enables an effective connection to the respective crash frame profile. By incorporating the reinforcing rib branches in the respective cross member end section, which is connected to the crash frame profile, an effective force transmission via the reinforcing rib branches into the reinforcing rib of the cross member center section is ensured.

In an example, the cross member end sections have, in addition to the reinforcing rib branches, non-deformed sections, which are each connected to the respective crash frame profile.

This achieves the technical advantage that the non-deformed sections enable a large connection area between the cross member end sections and the respective crash frame profile, which increases the structural stability of the connection of the cross member to the respective crash frame profile.

In an example, the reinforcing rib of the respective cross member extending along the respective cross member extension axis extends over the entire length of the cross member center section.

In particular, the reinforcing rib is connected at both ends to a plurality of reinforcing rib branches.

This achieves the technical advantage that an effective force introduction into the reinforcing rib of the cross member center section is achieved via the reinforcing rib branches.

In an example, the respective cross member end section of the respective cross member is connected to the respective crash frame profile in a materially bonded, form-fitting and/or force-fitting manner.

This achieves the technical advantage of achieving a structurally particularly stable connection between the respective cross member and the respective crash frame profile.

In an example, the cross members are connected to the base plate bottom side of the base plate in a materially bonded, form-fitting and/or force-fitting manner, wherein in particular the cross member center section of the respective cross member is connected to the base plate bottom side of the base plate in a materially bonded, form-fitting and/or force-fitting manner, in particular by spot weld bonding or laser welding.

This achieves the technical advantage of ensuring a particularly stable connection between the cross members and the base plate of the receiving tray.

In an example, the respective reinforcing rib has a reinforcing rib main section, which is connected to the reinforcing rib branches, wherein the reinforcing rib branches extend from the reinforcing rib main section in different directions.

This achieves the technical advantage that the reinforcing rib main section of the reinforcing rib enables an effective connection to the reinforcing rib branches.

In an example, the respective reinforcing rib has two end-side reinforcing rib branches, which extend, in particular in a V-shape, from the respective reinforcing rib, or the respective reinforcing rib has three end-side reinforcing rib branches, which extend, in particular in a trident shape, from the respective reinforcing rib.

This achieves the technical advantage that the two or three end-side reinforcing rib branches ensure an effective force introduction over a large area from the respective crash frame profile into the respective cross member.

In an example, the receiving tray has a plurality of partition walls, which are arranged on the base plate top side of the base plate facing the tray interior space and are adapted to divide the tray interior space into battery receiving sections for receiving individual battery modules.

This achieves the technical advantage of achieving an effective segmentation of the battery modules arranged in the interior of the tray, which also separates the battery modules from one another in the event of a collision.

In an example, the cross members and/or the crash frame profiles have connecting elements for connection to an underride guard of the vehicle.

This achieves the technical advantage that the underride guard of the vehicle protects the cross members and the receiving tray from damage at the bottom side.

In an example, the battery housing has a plurality of inner cross members, which are arranged on a base plate top side of the base plate facing the tray interior space, and/or which are arranged above the base plate top side of the base plate and are connected to the outer wall of the receiving tray.

This achieves the technical advantage that the structural stability of the receiving tray can be further increased by the inner cross members in addition to the cross members.

In particular, the inner cross members are connected at the ends via inner member connections to two opposite side wall sections of the outer wall and/or to the base plate.

In an example, the receiving tray is formed as a cold-formed receiving tray or a hot-formed receiving tray.

This achieves the technical advantage of providing a receiving tray with advantageous structural stability.

In an example, the cross members and/or the inner cross members are made of a hardened steel, which is in particular adapted as a hot-formed and press-hardened steel with a tensile strength of more than 1350 MPa or as a high-strength cold-formed steel with a tensile strength in a range of more than 600 MPa.

This achieves the technical advantage that the selected materials ensure particularly high structural stability of the battery housing.

In an example, the cross members each have a reinforcement patch in the respective cross member end section, which is adapted to increase the stiffness of the cross member end section compared to the cross member center section.

This achieves the technical advantage that an effective increase in the stiffness of the respective cross member end section by means of the one reinforcement patch enables an improved increase in the stability of the cross member.

In an example, the battery housing comprises a cover element, which has a further circumferential flange, wherein the further flange of the cover element is connected to the flange of the outer wall of the receiving tray in order to connect the cover element to the receiving tray.

This achieves the technical advantage that the cover element effectively seals off the tray interior space.

In an example, a plurality of stiffening beads is arranged on a base plate top side of the base plate of the receiving tray facing the tray interior space, which stiffening beads extend longitudinally and/or transversely on the base plate top side.

This achieves the technical advantage that the stiffening beads provide advantageous stabilization of the base plate.

In an example, the cross members and/or the inner cross members are each formed from a tailored blank component.

This achieves the technical advantage that a tailored blank component enables a particularly load-bearing and lightweight form of the cross members and/or the inner cross members, and these can be manufactured easily without subsequent joining processes.

### BRIEF DESCRIPTION OF THE DRAWINGS

Further examples are explained with reference to the accompanying figures.

FIG. 1 shows a schematic representation of a battery housing according to a first example;

FIGS. 2A through 2C show schematic representations of a cross member of the battery housing shown in FIG. 1 according to the first example in top view and in sectional views;

FIGS. 3A and 3B show schematic representations of a cross member of the battery housing shown in FIG. 1 according to a second example in top view and in sectional view;

FIG. 4 shows a schematic representation of a battery housing according to a third example;

FIGS. 5A and 5B show schematic representations of a cross member of the battery housing shown in FIG. 4 according to the third example in top view and in sectional view;

FIG. 6 shows a schematic representation of a battery housing according to a fourth example;

FIG. 7 shows a schematic representation of a battery housing according to a fifth example; and

FIG. 8 shows a schematic representation of a battery housing according to a sixth example.

### DETAILED DESCRIPTION

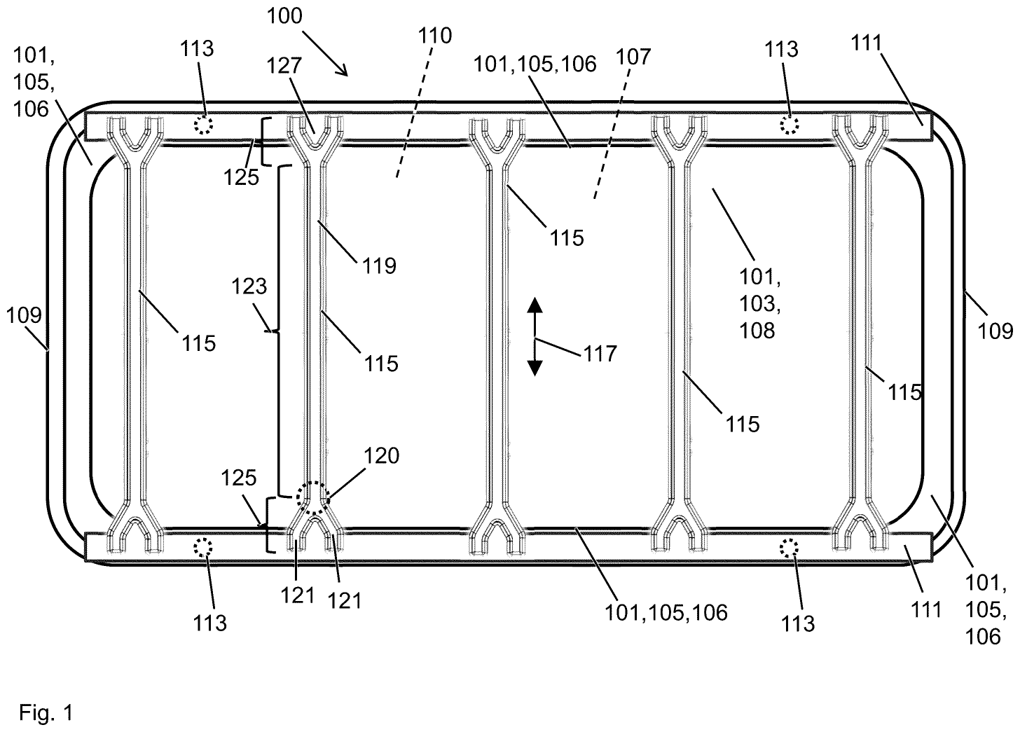

FIG. 1 shows a schematic representation of a battery housing according to a first example, in particular a battery housing 100 for receiving a plurality of battery cells or battery modules not shown in FIG. 1, in particular in an electrically powered vehicle. FIG. 1 shows a bottom view of the battery housing 100.

The battery housing 100 has a receiving tray 101, shown in FIG. 1, for receiving the plurality of battery cells or battery modules. The receiving tray 101 is formed in one piece.

The receiving tray 101 has a base plate 103 and an outer wall 105 arranged circumferentially around the base plate 103. The outer wall 105 consists of four side wall sections 106, with two of the four side wall sections 106 being arranged opposite one another.

The outer wall 105 defines a tray interior space 107 of the receiving tray 101, which is not visible in FIG. 1 and in which the battery cells or battery modules are received. The illustration in FIG. 1 shows the base plate bottom side 108 of the base plate 103 facing away from the tray interior space 107.

At the outer wall 105 of the receiving tray 101, a flange 109 is arranged, which circumfers the outer wall 105 and extends at an angle, in particular almost at a right angle, to the outer wall 105 of the receiving tray 101, wherein the flange 109 is formed in particular during the forming from the sheet material, for example by deep drawing.

The base plate 103 of the receiving tray 101 accommodates the plurality of battery cells or battery modules, although the battery cells or battery modules are not shown in FIG. 1. The plurality of electric battery cells or battery modules can be placed, in particular, on the base plate 103.

Here, the receiving tray 101 has in particular a plurality of partition walls, not shown in FIG. 1, which are arranged on the base plate top side 110 of the base plate 103 facing the tray interior space 107 and facing away from the base plate bottom side 108 and are adapted to divide the tray interior space 107 into battery receiving sections for receiving individual battery modules.

Although not shown in FIG. 1, the battery housing 100, in particular in the installed state, for example in a motor vehicle, has a cover element, which is connected to the flange 109 circumferring the outer wall 105 in order to close off the tray interior space 107 from an outer section of the battery housing 100. In particular, a further flange of the cover element is connected to the flange 109 of the outer wall 105, in particular in a materially bonded, form-fitting and/or force-fitting manner, in order to ensure an effective fastening of the cover element to the outer wall 105.

The receiving tray 101 consists in particular of sheet metal or a composite material comprising metal.

As can be seen from FIG. 1, the battery housing 100 further comprises a plurality of crash frame profiles 111, which are arranged on at least two side wall sections 106 of the outer wall 105 of the receiving tray 101 and which are adapted to absorb forces acting on the receiving tray 101 by deformation. FIG. 1 shows two opposing crash frame profiles 111, which are arranged at two opposite side wall sections 106 of the outer wall 105 of the receiving tray 101. Alternatively, however, it is also possible for the battery housing 100 to have four crash frame profiles 111, two of which are arranged on each of two opposite side wall sections 106 of the outer wall 105 of the receiving tray 101 in order to ensure an all-round protection of the receiving tray 101 against deformation.

The crash frame profiles 111 serve primarily to protect the receiving tray 101 from deformation or resulting damage to the battery cells, in particular in a side impact of the vehicle.

Although only shown schematically in FIG. 1, the crash frame profiles 111 have a plurality of coupling sections 113 for fastening the battery housing 100 to body longitudinal members, in particular vehicle sills, not shown in FIG. 1. The coupling sections 113 of the crash frame profiles 111 have, in particular, a plurality of passages through which a fastening element, in particular a fastening screw, not shown in FIG. 1, can be guided in order to fasten the battery housing 100 to the body longitudinal members, in particular vehicle sills.

Furthermore, the battery housing 100 has a plurality of cross members 115, each of which is connected to two crash frame profiles 111 of the plurality of crash frame profiles 111. The cross members 115 further stabilize the crash frame profiles 111 and improve the resistance of the receiving tray 101 to deformation.

Although not shown in the view selected in FIG. 1, the cross members 115 are formed, at least in sections, as respective profile bodies open at least on one side and are connected to the respective crash frame profile 111. The side of the cross members 115 open at least in sections on one side faces the respective crash frame profile 111. The cross members 115 extend along a cross member extension axis 117.

From FIG. 1, it can be seen that the cross members 115 are arranged on the base plate bottom side 108 of the base plate 103 of the receiving tray 101. In particular, the cross members 115 are arranged parallel to one another.

The cross members 115 each have a reinforcing rib 119 extending along the respective cross member extension axis 117, wherein the respective reinforcing rib 119 spreads out into a plurality of reinforcing rib branches 121 in the section of the profile body open at least on one side.

The respective reinforcing rib 119 has in particular a reinforcing rib main section 120, which is connected to the reinforcing rib branches 121, wherein the reinforcing rib branches 121 extend from the reinforcing rib main section 120 in different directions.

In particular, the cross members 115 each have a cross member center section 123 and two cross member end sections 125 formed in one piece with the cross member center section 123. In particular, the cross member end sections 125 are each formed as profile bodies open on at least one side which are connected to the respective crash frame profile 111 from below in the installed position, and wherein the plurality of reinforcing rib branches 121 of the respective reinforcing rib 119 are formed in the respective cross member end section 125. Thus, the cross member end sections 125 have a greater width than the cross member center section 123 of the respective cross member 115. The width refers to the width of the profiling or the reinforcing rib itself, even if the reinforcing rib can be formed as circumferential flat sheet metal sections or non-deformed sections.

The introduction of the reinforcing rib branches 121 into the respective cross member end sections 125 of the respective cross member 115, in combination with the connection to the respective crash frame profile 111, enables an advantageous force transmission to the crash frame profile 111 in a side impact, for example in the context of a “side pole crash”, in which a pole hits the area between the front and rear doors of the vehicle at a speed of 32 km/h.

The resulting forces are introduced and effectively transported by the reinforcing rib branches 121 of the respective cross member end sections 125 into the main load path of the cross member center section 123 of the respective cross member 115. According to this disclosure, the reinforcing rib branches 121 are located at the position most susceptible to bending during a side impact, approximately between the crash frame profile 111 and the respective cross member 115, thereby increasing the flexural stiffness and the maximum permissible force level. The point most susceptible to bending may vary slightly depending on the type and design of the vehicle body.

In addition, the widening of the cross member end sections 125 of the respective cross member 115 enables a weight saving due to the smaller width of the cross member center section 123 of the respective cross member 115, which is particularly advantageous in an electrically powered vehicle.

In particular, the cross member end sections 125 have, in addition to the reinforcing rib branches 121, non-deformed sections 127, which are each connected to the respective crash frame profile 111. The non-deformed sections 127 are not visible in FIG. 1 due to the weak contrast, so reference is made to the following figures in this regard.

In particular, the reinforcing rib 119 of the respective cross member 115 extending along the respective cross member extension axis 117 extends over the entire length of the cross member center section 123.

In particular, the respective cross member end section 125 of the respective cross member 115 is connected to the respective crash frame profile 111 in a materially bonded, form-fitting and/or force-fitting manner.

Hereby, the main joint is enlarged and more connection points or connection surfaces between the cross members 115 and the respective crash frame profile 111 are provided, which are carried out, for example, by spot weld bonding or laser welding.

From FIG. 1 it can also be seen that the respective reinforcing rib 119 has two end-side reinforcing rib branches 121, which extend, in particular in a V-shape, from the respective reinforcing rib 119.

In particular, the cross members 115, in particular the cross member center section 123 of the respective cross member 115, are connected to the base plate bottom side 108 of the base plate 103 in a materially bonded, form-fitting and/or force-locked manner, in particular by spot weld bonding or laser welding.

In particular, the cross members 115 and/or the crash frame profiles 111 have connecting elements (not shown in FIG. 1) for a preferably detachable connection to an underride guard of the vehicle (not shown in FIG. 1).

In particular, the battery housing 100 has a plurality of inner cross members (not shown in FIG. 1), which are arranged on a base plate top side 110 of the base plate 103 facing the tray interior space 107, and/or which are arranged above the base plate top side 110 of the base plate 103 and are connected to the outer wall 105 of the receiving tray 101.

In particular, the cross members 115 and/or the inner cross members are made of a hardened steel, which is in particular adapted as a hot-formed and press-hardened steel with a tensile strength of more than 1350 MPa or as a high-strength cold-formed steel with a tensile strength in a range of more than 600 MPa.

The cross members 115 and/or the inner cross members may each be formed from a tailored blank component in order to better meet lightweight construction requirements.

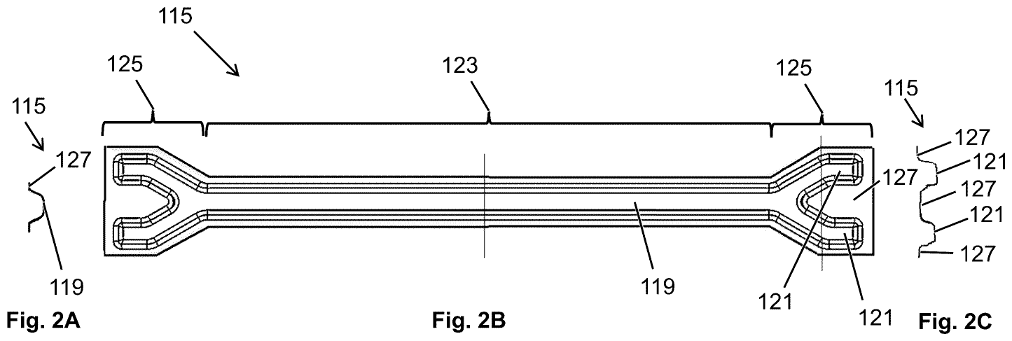

FIGS. 2A to 2C show schematic representations of a cross member of the battery housing shown in FIG. 1 according to the first example in perspective and in sectional views.

FIG. 2B shows an enlarged top view of the cross member 115, which has already been described in detail with reference to FIG. 1 and has the cross member center section 123, in particular for attachment to the base plate 103 of the receiving tray 101, and cross member end sections 125 extending therefrom for attachment to the crash frame profiles 111. The cross member 115, in particular the cross member end sections 125, has a plurality of reinforcing rib branches 121, which enable an effective force introduction.

FIG. 2A further shows a cross section through the cross member center section 123 and FIG. 2C further shows a cross section through the cross member end section 125, so that according to FIGS. 2A and 2C, the form of the cross member 115 as a profile body open on one side with an open profile body bottom side is clearly evident.

From the illustration in FIG. 2B, it can be seen that, in addition to the reinforcing rib branches 121, there are non-deformed sections 127 in the respective cross member end section 125, in which non-deformed sections 127 no profiling has been introduced into, but rather the sheet metal extends horizontally in the installed situation. In the non-deformed sections 127, welding, such as spot welding, is preferably performed to the crash frame profile 111.

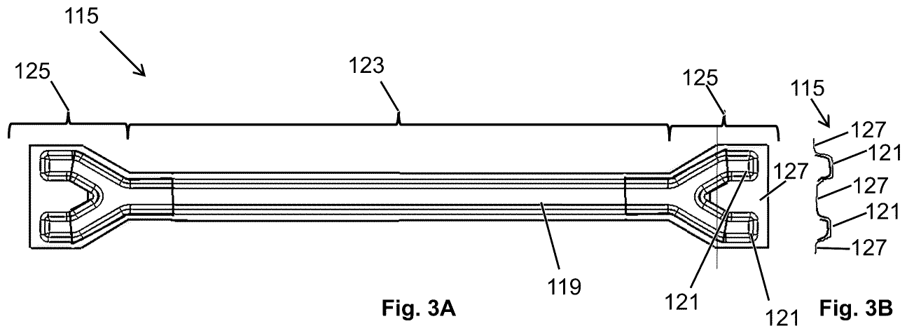

FIGS. 3A to 3B show schematic representations of a cross member of the battery housing shown in FIG. 1 according to a second example, in top view and in sectional view. Reference is made to the explanations regarding FIGS. 2A to 2C.

Here, FIG. 3A shows the cross member 115 according to the second example in top view and FIG. 3B shows the cross member end section 125 of the cross member 115 in a sectional view according to the second example.

The cross member 115 shown in FIGS. 3A and 3B according to the second example differs from the cross member 115 shown in FIGS. 2A, 2B and 2C according to the first example in that the cross member end section 125 has a double-layered profiling, with different wall thicknesses in particular in the section of the reinforcing rib branches 121 and in the section of the non-deformed sections 127. This example is possible in particular through the use of reinforcement patches, wherein the patches are applied, fixed, and jointly formed into the profile body or cross member prior to forming.

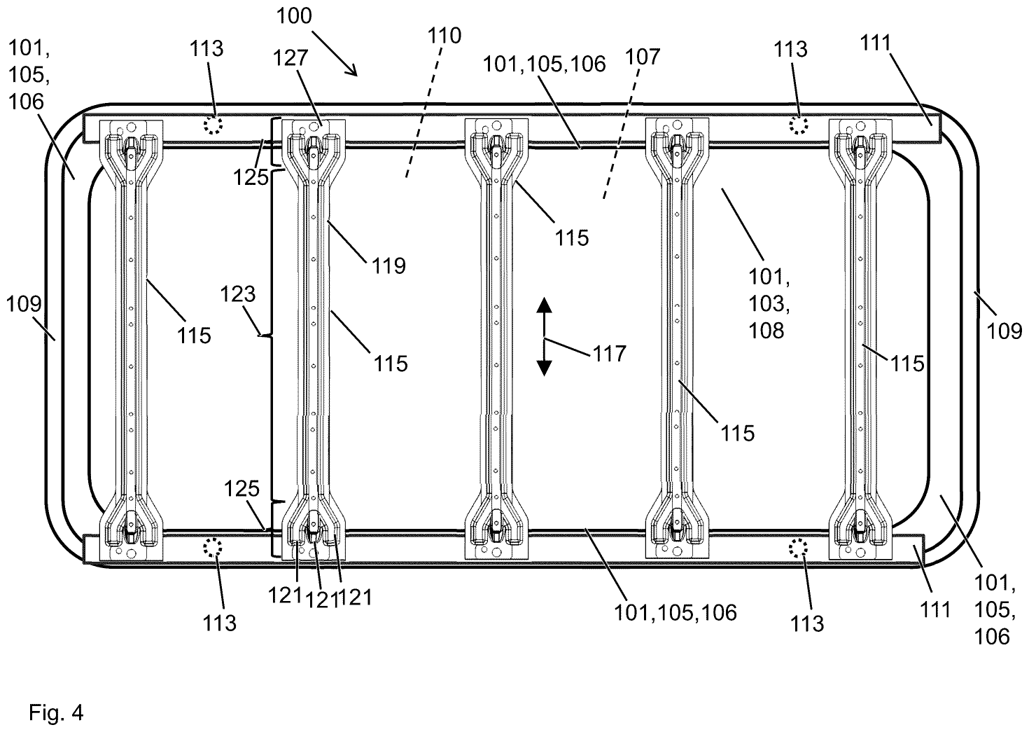

FIG. 4 shows a schematic representation of a battery housing according to a third example.

The battery housing 100 according to the third example shown in FIG. 4 differs from the battery housing 100 according to the first example shown in FIG. 1 only in the shape of the cross members 115.

In the third example shown in FIG. 4, the cross member end sections 125 of the cross members 115 each have three end-side reinforcing rib branches 121, which extend, in particular in a trident shape, from the respective reinforcing rib 119.

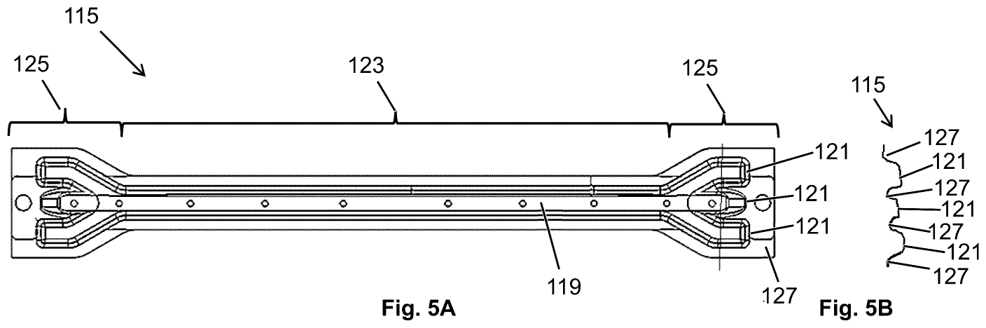

FIGS. 5A to 5B show schematic representations of a cross member of the battery housing shown in FIG. 4 according to the third example in top view and in sectional view.

FIG. 5A shows the top view of the cross member 115, comprising the three end-side reinforcing rib branches 121 in the cross member end section 125.

FIG. 5B shows a sectional view of the cross member end section 125 of the cross member 115, comprising the three end-side reinforcing rib branches 121, as well as the non-deformed sections 127 arranged therebetween.

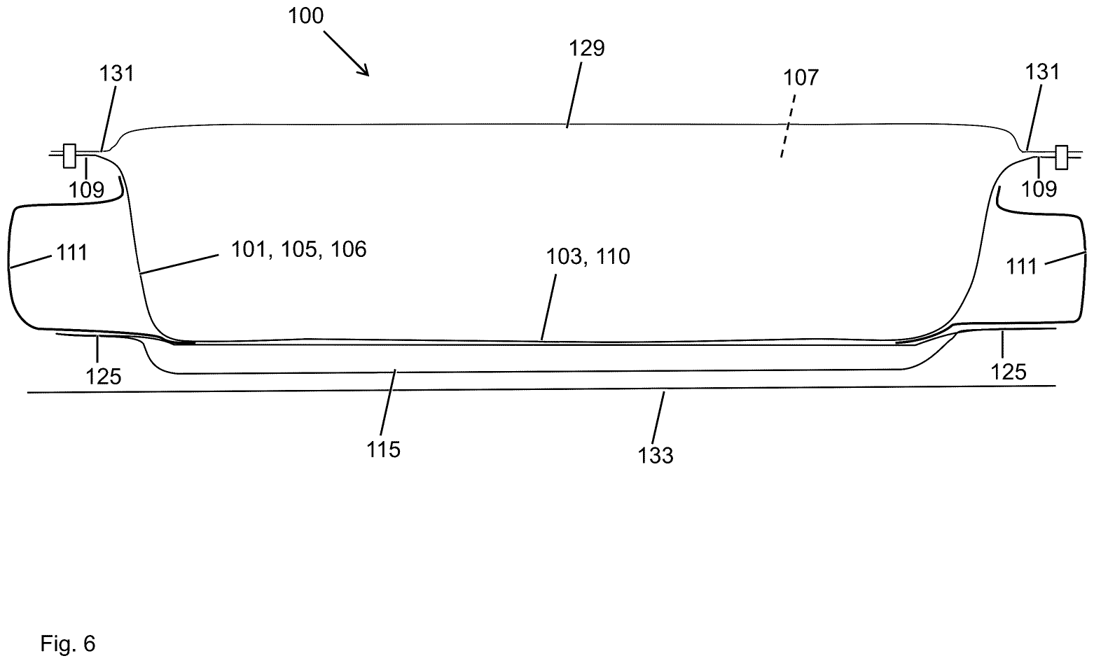

FIG. 6 shows a schematic representation of a battery housing according to a fourth example.

In contrast to the previous examples, FIG. 6 shows a sectional view through the battery housing 100, which is only shown schematically.

The battery housing 100 has the receiving tray 101 with the base plate 103 and the outer wall 105 surrounding the base plate 103 with corresponding side wall sections 106, wherein a circumfering flange 109 is arranged on the outer wall 105, which is connected to a further flange 131 of a cover element 129 of the receiving tray 101 in order to effectively close off the tray interior space 107 and the battery modules or battery cells received therein.

The crash frame sections 111, shown only schematically in FIG. 6, are arranged at the outer wall 105 and are joined to the outer wall 105 and the base plate 103. Here, the crash frame profiles 111 are each adapted as a single-shell structure. Here, the crash frame sections 111 may each have at least one hollow chamber extending along the respective side wall section 106 of the outer wall 105.

Arranged below the base plate 103 are the cross members 115, which are connected by their respective cross member end sections 125 to opposite crash frame sections 111. The reinforcing rib 119 and the reinforcing rib branches 121 of the cross members 115 are not shown in FIG. 6.

Furthermore, the cross members 115 and/or the crash frame profiles 111 have connecting elements (not shown in FIG. 6) for connection to an underride guard 133 of the vehicle shown in FIG. 6.

For further details regarding the battery housing 100, reference is made to the explanations of the previous examples.

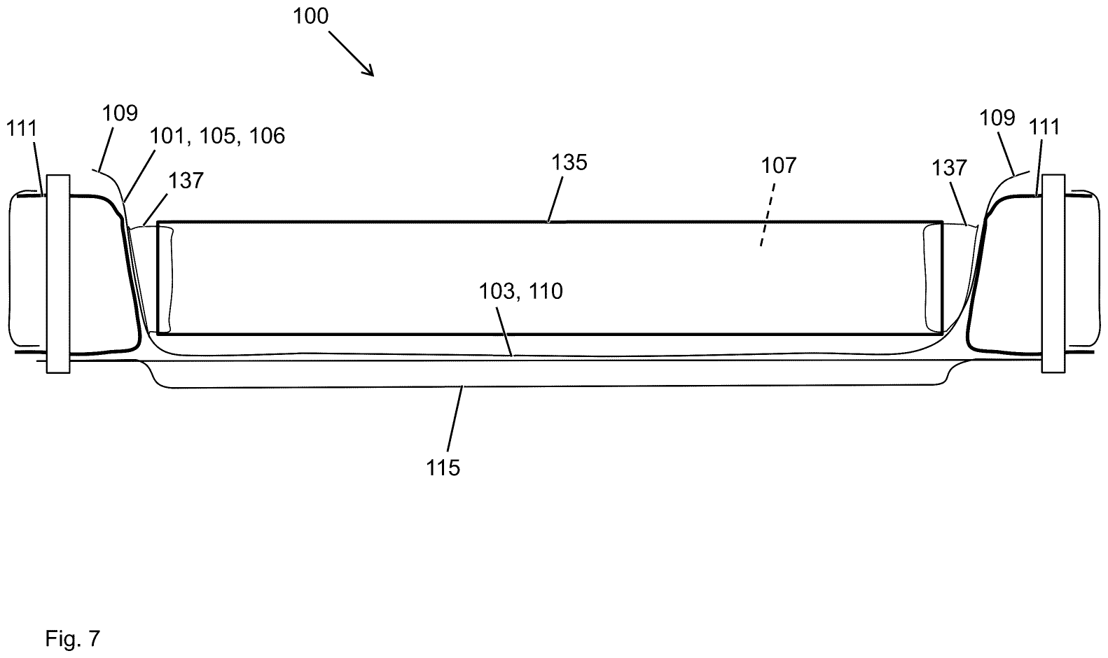

FIG. 7 shows a schematic representation of a battery housing according to a fifth example.

The battery housing 100 shown in FIG. 7 according to the fifth example differs from the battery housing 100 shown in FIG. 6 according to the fourth example, except for the underride guard 133 not shown in FIG. 7, in that there is no cover element 129, but the flanges 109 of the receiving tray 101 are connected to an underbody of the vehicle body not shown in FIG. 7, that the crash frame profiles 111 are each adapted as a double shell, that the crash frame profiles 111 are joined to the respective side wall section 106 of the outer wall 105, and that inner cross members 135 are arranged in the tray interior space 107 of the receiving tray 101, which are connected at the ends via inner cross member connections 137 to two opposite side wall sections 106 of the outer wall 105.

Although not shown in FIG. 7, the crash frame profiles 111, each of which is adapted as a double shell, may also be adapted with an upper and a lower hollow chamber, which each extend along the side wall sections 106 of the outer wall 105 and are joined to the respective side wall section 106 of the outer wall 105 and/or the base plate 103.

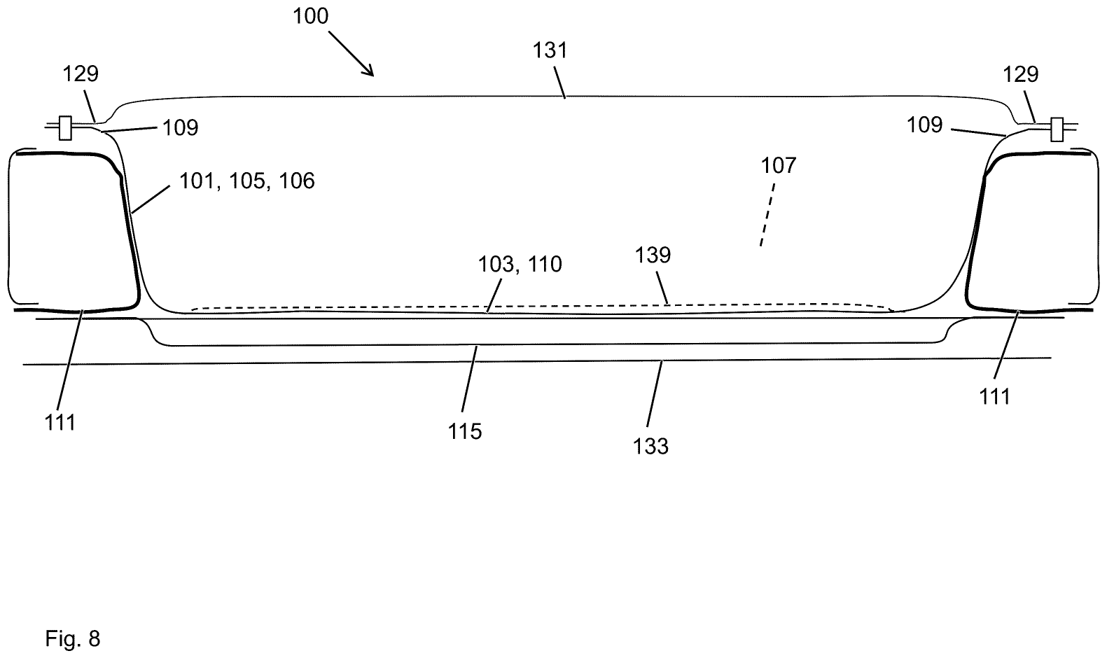

FIG. 8 shows a schematic representation of a battery housing according to a sixth example.

The battery housing 100 according to the sixth example shown in FIG. 8 differs from the battery housing 100 according to the fourth example shown in FIG. 6 in that, analogously to the fifth example of FIG. 7, the crash frame profiles 111 are each adapted as a double shell and are joined to the respective side wall section 106 of the outer wall 105, and in that a plurality of only schematically illustrated stiffening beads 139 are arranged on the base plate top side 110 of the base plate 103 of the receiving tray 101 facing the tray interior space 107, which stiffening beads 139 extend longitudinally and/or transversely on the base plate top side 110.

What is claimed is:

1. A battery housing for receiving a plurality of battery cells or battery modules, comprising:
a receiving tray for receiving the plurality of battery cells or battery modules, wherein the receiving tray has a base plate and an outer wall, which is arranged circumferentially around the base plate, wherein the outer wall delimits a tray interior space of the receiving tray,
wherein a flange circumferring the outer wall is arranged on the outer wall of the receiving tray, and wherein the flange extends at an angle to the outer wall of the receiving tray;
a plurality of crash frame profiles, which are arranged on at least two side wall sections of the outer wall of the receiving tray, and which are adapted to absorb forces acting on the receiving tray by a deformation,
wherein the plurality of crash frame profiles have a plurality of coupling sections for fastening the battery housing to body longitudinal members; and
a plurality of cross members, which are each connected to two crash frame profiles of the plurality of crash frame profiles,
wherein the plurality of cross members are formed at least in sections as profile bodies, which are connected to a respective crash frame profile, and
wherein the plurality of cross members each have a greater tensile strength or stiffness in respective cross member end sections compared to a respective cross member center section.

2. The battery housing according to claim 1, wherein the stiffness of a respective cross member end section is increased by a respective reinforcing rib extending along a respective cross member extension axis, and wherein the respective reinforcing rib spreads out in the respective cross member end section into a plurality of reinforcing rib branches.

3. The battery housing according to claim 2, wherein the plurality of cross members each have a cross member center section and each have two cross member end sections formed in one piece with the cross member center section, wherein the respective cross member end sections are each formed as profile bodies, which are connected to the respective crash frame profile, and wherein the plurality of reinforcing rib branches of the respective reinforcing rib is formed in the respective cross member end section.

4. The battery housing according to claim 2, wherein the respective cross member end sections have, in addition to the plurality of reinforcing rib branches, non-deformed sections, which are each connected to the respective crash frame profile.

5. The battery housing according to claim 2, wherein the respective reinforcing rib extending along the respective cross member extension axis extends over an entire length of the respective cross member center section.

6. The battery housing according to claim 2, wherein the respective reinforcing rib has two end-side reinforcing rib branches, which extend in a V-shape from the respective reinforcing rib, or wherein the respective reinforcing rib has three end-side reinforcing rib branches, which extend in a trident shape from the respective reinforcing rib.

7. The battery housing according to claim 1, wherein coupling sections of the plurality of crash frame profiles each have at least one passage, through which a fastening element is guided in order to fasten the battery housing to the body longitudinal members.

8. The battery housing according to claim 1, wherein the plurality of cross members is arranged on a base plate bottom side of the base plate facing away from the tray interior space.

9. The battery housing according to claim 1, wherein the respective crash frame profile with a respective side wall section of the outer wall delimits at least one hollow chamber extending along the respective side wall section, or wherein the respective crash frame profile is a hollow chamber profile.

10. The battery housing according to claim 1, wherein a respective cross member end section of a respective cross member is connected to the respective crash frame profile in a materially bonded manner, in a form-fitting manner, in a force-fitting manner, or any combination thereof.

11. The battery housing according to claim 1, wherein the plurality of cross members are connected to a base plate bottom side of the base plate in a materially bonded manner, in a form-fitting manner, in a force-fitting manner, or any combination thereof, wherein the respective cross member center section of a respective cross member is connected to the base plate bottom side of the base plate in a materially bonded manner, in a form-fitting manner, in a force-fitting manner, or any combination thereof, by spot weld bonding or laser welding.

12. The battery housing according to claim 1, wherein the plurality of cross members, the plurality of crash frame profiles, or both have connecting elements for connection to an underride guard of a vehicle.

13. The battery housing according to claim 1, wherein the battery housing has a plurality of inner cross members, which are arranged on a base plate top side of the base plate facing the tray interior space, or which are arranged above a base plate top side of the base plate and are connected to the outer wall of the receiving tray, or both.

14. The battery housing according to claim 1, wherein the plurality of cross members, a plurality of inner cross members, or both, are made of a hardened steel, which is adapted as a hot-formed and press-hardened steel with a tensile strength of more than 1350 MPa or as a high-strength cold-formed steel with a tensile strength in a range of more than 600 MPa.

15. The battery housing according to claim 1, wherein the respective cross member end sections each have a reinforcement patch, which is adapted to increase the stiffness of the respective cross member end sections relative to the respective cross member center section.

16. The battery housing according to claim 1, wherein the battery housing is in an electrically driven vehicle.

17. The battery housing according to claim 1, wherein the receiving tray comprises a one-piece and formed receiving tray.

18. The battery housing according to claim 1. wherein the body longitudinal members comprise vehicle stills.
